(19) United States
(12) Patent Application Publication
(10) Pub. No.: US 2012/0310540 A1
(43) Pub. Date: Dec. 6, 2012

(54) SYSTEMS AND METHODS FOR ESTIMATING PHOTOSYNTHETIC CARBON ASSIMLATION

(75) Inventors: Dayle K. McDERMITT, Lincoln, NE (US); Patrick B. Morgan, Lincoln, NE (US); Tom Avenson, Lincoln, NE (US)

(73) Assignee: LI-COR, INC., Lincoln, NE (US)

(21) Appl. No.: 13/485,544

(22) Filed: May 31, 2012

Related U.S. Application Data
(60) Provisional application No. 61/491,814, filed on May 31, 2011.

(51) Int. Cl. G06F 19/00; G01J 1/58

(52) U.S. Cl. 702/19

(57) ABSTRACT

Methods, devices, and systems for measuring carbon assimilation based on simultaneous or near-simultaneous measurements of chlorophyll fluorescence and stomatal conductance of plant. A sample containing chlorophyll, such as a plant leaf, is illuminated with light, e.g., in the form of a single saturating pulse or multiple pulses, and chlorophyll fluorescence and stomatal conductance of the chlorophyll sample are measured. A porometer or infra-red gas analyzer is used to measure stomatal conductance and a photodetector is used to measure fluorescence. A carbon assimilation value for the chlorophyll sample is determined using the measured chlorophyll fluorescence and the measured stomatal conductance.

### CROSS-REFERENCES TO RELATED APPLICATIONS

This application claims the benefit of, and priority to, U.S. provisional Patent application No. 61/491,814, filed May 31, 2011, the contents of which are hereby incorporated by reference.

### BACKGROUND

The present invention is generally related to photosynthesis measurement systems, devices, and methods and more particularly to systems, methods and devices for estimating photosynthetic carbon assimilation.

Solar energy powers our ecosystem through the exquisite process of photosynthesis. Photosynthesis converts solar energy into chemical energy that is utilized by a series of enzymes to assimilate atmospheric CO₂ into carbon skeletons used to build virtually all organs of plants, algae, etc.

In conjunction with simple, mathematical models of CO₂ and H₂O fluxes between a leaf and its' environment, infrared detection of CO₂ and H₂O gases is one means of quantifying CO₂ assimilation in plants, but this information directly pertains to only a portion of the photosynthetic process.

Techniques using chlorophyll fluorescence have been developed to quantify the absorption and conversion of solar energy into the chemical energy used by the CO₂ assimilatory reactions. Fluorescence is one of several pathways by which singlet, excited chlorophyll can decay back to its' ground state after absorbing a photon, the wavelength of fluorescence being red-shifted relative to the initial excitation wavelength (see, e.g., FIG. 1). Combining information from these independent techniques (i.e., infrared detection of CO₂, etc., and fluorescence) of the same photosynthetic process can provide critical information about how: 1) CO₂ and light absorption reactions are coupled in plant tissue; 2) plants tolerate various biological and environmental stresses; 3) light capture is regulated at the leaf level; and 4) all of these processes are impacted by genetic manipulation, a process that has contributed to the increased yield of various species over the past several decades.

Fluorescence can be used to measure the flow of electrons through photosystem II (PSII), which is one of the first systems of a plant to be affected and damaged by stress. Fluorescence experiments can distinguish between the extent and type of plant stress as well as measure the impact of that stress on photosynthesis. For example, fluorescence measurements can help to determine whether a plant is stressed by heat or a lack of water.

The quantum efficiency of photosystem II (ΦPSII) can be measured by fluorescence, and is tied to plant stress as well as other physiological attributes.

The PSII electron transport rate (ETR) can be calculated from the products of ΦPSII, the actinic light intensity, the fraction of actinic light absorbed by the leaf, and the proportion of the absorbed light actually partitioned to PSII.

The light harvesting capacity of leaves can be measured using the proportion of light that is re-emitted as fluorescence, a process that is controlled by unique PSII reaction center redox dynamics. The measurement of light harvesting and utilization is an important indicator of photosynthetic capacity of plants, and alterations in this capacity can be indicative of various physiological stresses to the plant.

Traditional methods of estimating the maximum Φ_{F} (Fm′) have relied on very bright (e.g., up to 10× full sunlight) flashes of light applied for short periods (typically between 0.5 to 1 second). There is potential for these highly saturating pulses to be damaging to the photosynthetic light capturing proteins and molecules.

Stomatal conductance is another property important for understanding photosynthesis. Stomatal conductance (gₛ) is indicative of water use by the plant; the higher the conductance, the greater the water use. Water efflux from the leaf through open stomata is the same pathway through which CO₂ enters the leaf for assimilation. Both gₛ and ETR are important in and of themselves as indicators of plant health and photosynthetic activity. Together, stomatal conductance and chlorophyll fluorescence can be used to obtain a complete picture of net photosynthesis. However, there are currently no available instruments that take advantage of the speed and simplicity of measuring only gₛ and ETR together to estimate net carbon assimilation.

There exists a need in the art for better and more rapid measurements of fluorescence stomatal conductance as well as carbon assimilation to assess plant stress.

### BRIEF SUMMARY

Various embodiments provide systems and methods for simultaneously measuring water conductance through open stomata in a leaf's surface and chlorophyll fluorescence, both of which are used to estimate net CO₂ assimilation during photosynthesis. The measured stomatal conductance (gₛ) is indicative of water use by the plant; the higher the conductance, the greater the water use. Water efflux from the leaf through open stomata is the same pathway through which CO₂ enters the leaf for assimilation. Chlorophyll fluorescence is used to measure the quantum efficiency with which absorbed light is utilized to drive PSII electron transport, or Φ_{PSII}. Since PSII is responsible for the light-driven oxidation of H₂O to generate electrons, estimation of Φ_{PSII} can subsequently be used to quantify the electron transport rate (ETR) of the predominant pathway of photosynthetic electron transport. The ETR is directly related to the formation of chemical intermediates that store energy for carbon metabolism. Both gₛ and ETR are important in and of themselves as indicators of plant health and photosynthetic activity. When used together in a novel formulation of the Farquar model of photosynthesis, gₛ and ETR are used to obtain a complete picture of carbon assimilation of the leaf.

According to an embodiment, a method is provided for estimating carbon assimilation of a sample containing chlorophyll (chlorophyll sample). The method typically includes illuminating the chlorophyll sample with light, measuring a chlorophyll fluorescence of the chlorophyll sample, and measuring a stomatal conductance of the chlorophyll sample. The method also typically includes calculating a carbon assimilation value for the chlorophyll sample based on the measured chlorophyll fluorescence and the measured stomatal conductance. In certain aspects, calculating includes determining a maximal fluorescence value (Fm′) of the chlorophyll sample using the measured chlorophyll fluorescence, and estimating an effective quantum efficiency of a photosystem II (Φ_{PSII}) or electron transport (ETR) of the chlorophyll using the Fm′ value, wherein the carbon assimilation value for the chlorophyll sample is calculated using the ETR value and the measured stomatal conductance. In certain aspects, illuminating the chlorophyll sample includes applying a pulse of saturating light upon the chlorophyll sample. In certain aspects, illuminating the chlorophyll sample further includes varying an intensity of the saturating light during the pulse. In certain aspects, varying the intensity includes adjusting the intensity such that the applied pulse has a shape of a rectangular pulse of a first intensity, immediately followed by a ramp down in intensity. In certain aspects, the ramp down is immediately followed by another rectangular flash of the first intensity, thereby replicating a multiphase single flash (MPF). In certain aspects, the sample includes plant tissue such as a leaf or other photosynthetic plant tissue, or a non-plant photosynthetic organism or apparatus. In certain aspects, measuring a stomatal conductance of the chlorophyll sample is done using one of a porometer or an infra-red gas analyzer (IRGA).

According to another embodiment, a plant photosynthesis monitoring system is provided that typically includes a first illumination source configured to illuminate a sample area with light, a first detector configured to measure a chlorophyll fluorescence of a chlorophyll sample in the sample area, and a detector system configured to measure a stomatal conductance of the chlorophyll sample. The photosynthesis monitoring system also typically includes a processor adapted to calculate a carbon assimilation value for the chlorophyll sample based on the measured chlorophyll fluorescence and the measured stomatal conductance. In certain aspects, the processor is further adapted to determine a maximal fluorescence (Fm′) using the measured chlorophyll fluorescence from the first detector, and estimate an effective quantum efficiency of a photosystem II (Φ_{PSII}) or electron transport (ETR) of the chlorophyll sample using the Fm′ value, wherein the processor calculates the carbon assimilation value for the chlorophyll sample using the ETR value and the measured stomatal conductance. In certain aspects, the first illumination source is configured to illuminate the chlorophyll sample in the sample area by applying a pulse of saturating light, wherein first detector measures the chlorophyll fluorescence from the sample area during the pulse. In certain aspects, the first illumination source is configured to vary an intensity of the saturating light during the pulse. In certain aspects, the first illumination source varies the intensity of the saturating light by adjusting the intensity such that the applied pulse has a shape of a rectangular pulse of a first intensity, immediately followed by a ramp down in intensity. In certain aspects, the ramp down is immediately followed by another rectangular flash of the first intensity, thereby replicating a multiphase single flash (MPF). In certain aspects, the first detector includes a photodetector and the detector system includes one of a porometer or an infra-red gas analyzer (IRGA).

According to yet another embodiment, a plant photosynthesis monitoring system is provided that typically includes a first illumination source configured to illuminate a sample area with light, a fluorescence detector configured to measure a chlorophyll fluorescence of a chlorophyll sample in the sample area, and a porometer or infra-red gas analyzer configured to measure a stomatal conductance of the chlorophyll sample. The system also typically includes a processor adapted to calculate a carbon assimilation value for the chlorophyll sample based on the measured chlorophyll fluorescence and the measured stomatal conductance.

In certain aspects, far-red light (e.g., light between about 700 and 800 nm in wavelength) is projected while flashing a saturating light at a plant leaf in order to measure chlorophyll fluorescence. The measured fluorescence can then be used to determine Fm′, Φ_{PSII}, and the ETR of the plant leaf tissue.

Embodiments herein relate to a method of analyzing chlorophyll fluorescence. The method includes flashing a saturating light upon chlorophyll, and varying an intensity of the saturating light during the flash. In certain aspects, a chlorophyll fluorescence of the chlorophyll is measured during the varying and a maximal fluorescence (Fm′) of the chlorophyll is determined using the measured chlorophyll fluorescence. In certain aspects, the chlorophyll is also irradiated with far-red light. In certain aspects, the irradiating occurs during the varying of the intensity of the saturating light and the chlorophyll fluorescence of the chlorophyll is measured during the both varying and irradiating.

Some embodiments herein relate to a plant photosynthesis fluorometer apparatus. The apparatus includes a first lamp configured to flash a saturating light pulse toward a sample area and configured to vary an intensity of the saturating light during the pulse. In certain aspects, and a second lamp configured to irradiate far-red light during a flash from the first lamp toward the sample area is provided. Also provided is a detector configured to measure a chlorophyll fluorescence from the sample area during a flash from the first lamp, and the second lamp when present, and a computing device configured to determine a maximal fluorescence (Fm′) using the measured chlorophyll fluorescence from the detector.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 (right and left) includes charts showing the phenomenon of fluorescence.

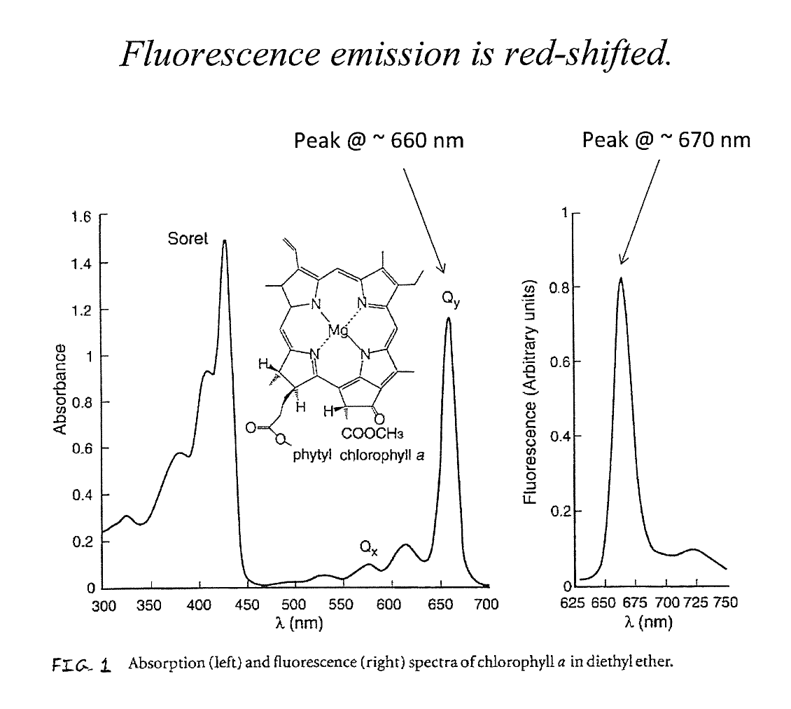

FIG. 2 is an example of a system adapted to determine carbon assimilation of a sample according to an embodiment.

FIG. 3 shows a portable device in accordance with an embodiment.

FIG. 4 shows three charts illustrating saturating flashes or pulses: FIG. 4a shows a typical rectangular shaped pulse; FIG. 4B shows a train of rectangular pulses separated in time by approximately 2 minutes; and FIG. 4C shows a single multiphase flash or pulse in accordance with an embodiment.

FIG. 5 illustrates a lamp and sensor area of a device in accordance with an embodiment.

FIG. 6 illustrates a gun-like fluorometer concept according to an embodiment.

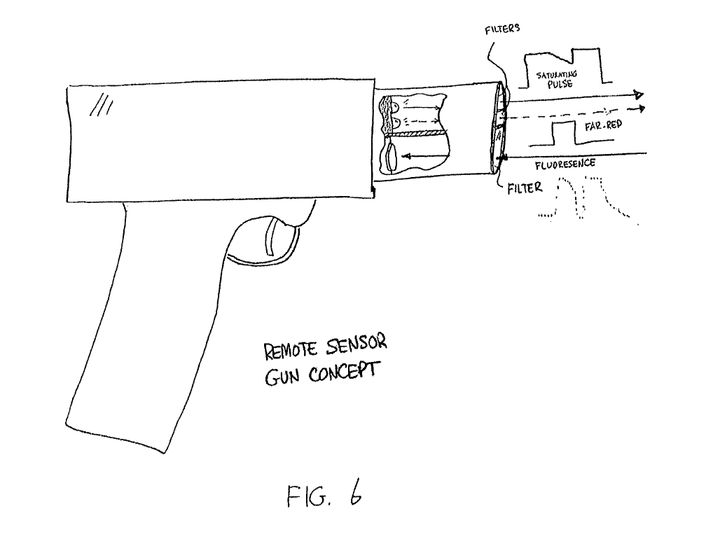

### DETAILED DESCRIPTION

Generally, methods, devices, and systems for estimating photosynthetic carbon assimilation from measured stomatal conductance (gₛ) and electron transport rates (ETR) of chlorophyll-containing tissue, such as that in plant tissue/leaves, are presented.

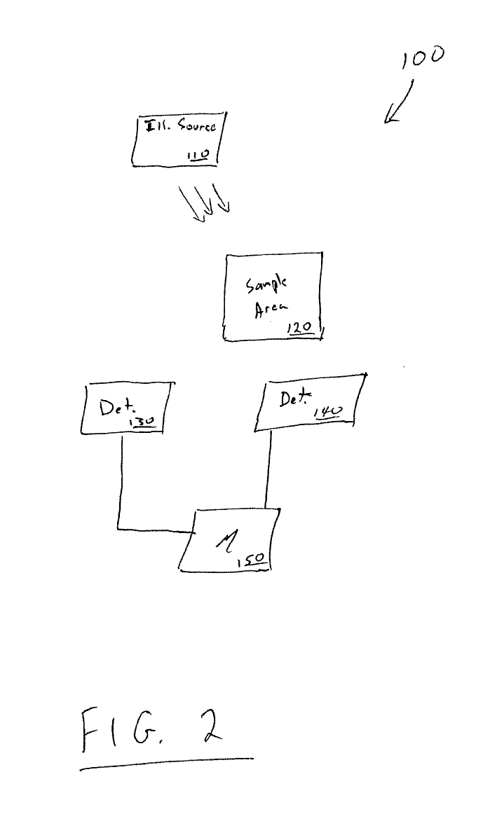

FIG. 2 illustrates a system 100 for calculating a value of carbon assimilation for a sample containing chlorophyll according to one embodiment. System 100 includes an illumination or excitation source 110 configured to illuminate a sample area 120 with light of a specific wavelength or range of wavelengths (e.g., monochromatic light, or broadband encompassing a wide range of wavelengths). Examples of useful light sources include lasers, photodiodes, lamps, such as xenon bulbs or arc lamps, quartz halogen lamps, tungsten lamps, mercury-vapor lamps and other discharge lamps, light-emitting diodes (LEDs) of various colors (e.g., white red, blue, etc). Where a broadband source is used, such as a white light source, one or more filters may be used to narrow the spectrum of light impinging on the sample area. Excitation source 110 may include multiple light sources in certain embodiments, each configured to illuminate the sample area with light of a different wavelength or wavelength range. Excitation source 110 is provided to excite a sample containing a fluorescent species, such as chlorophyll, whereby the fluorescent species absorbs light within its absorption spectrum and emits fluorescent light at one or more different, longer (red-shifted) wavelengths. A fluorescence detector 130 is provided to detect the fluorescent emissions from the sample in the sample area and generate a signal representative of the amount of fluorescent light detected. Using the measured fluorescence of the sample under investigation, the ETR can be calculated as set forth in more detail below. It is desirable that the detector 130 be positioned in a manner to reduce the amount of excitation light reflecting from the sample area onto the detector. Additionally or alternately, filters to remove excitation light may be used. Useful detectors include any of a variety of single-channel or multi-channel detectors, such as photodetectors, photocells, CCD chips and other imaging chips, gallium arsenide detectors, silicon diode based detectors, etc.

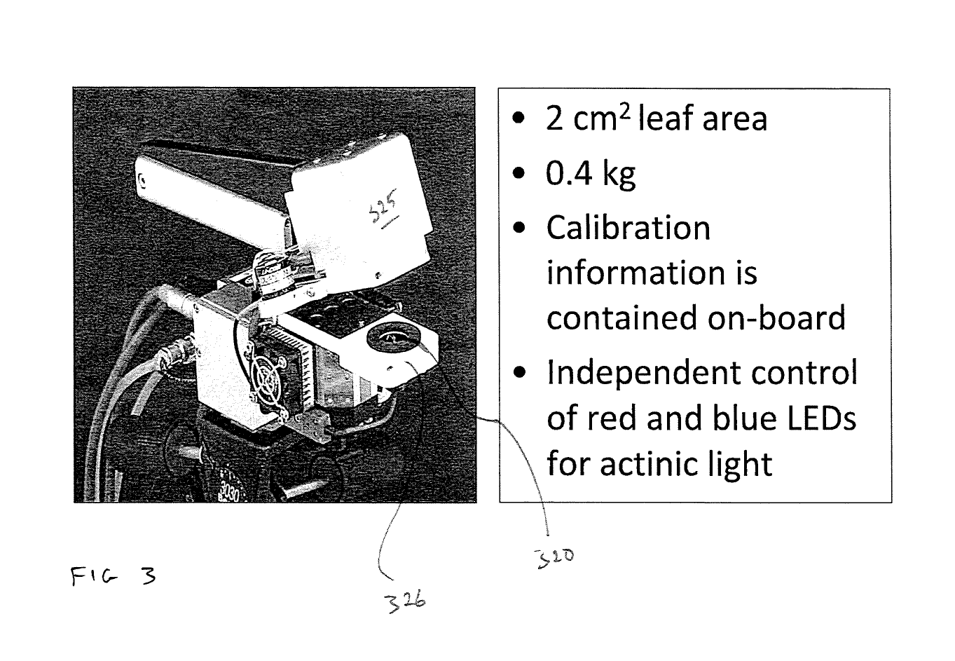

System 100 also includes a second detector system 140 positioned and arranged to measure the stomatal conductance of a sample in the sample area. Useful detector systems for measuring stomatal conductance include porometers, such as steady state porometers, dynamic or transient porometers and null balance porometers, as well as gas analyzers such as infra-red gas analyzers (IRGAs). For a porometer, the actual detector might include a sensor, such as a capacitive humidity detector, which detects the humidity in the porometer, or the rate of change in humidity, depending upon whether it is a steady state instrument or a transient instrument. In general, for the case of a plant tissue sample, any detector system or instrument capable of measuring the rate of passage of water vapor exiting the stomata of the plant tissue can be used to provide a measure of the stomatal conductance. In operation, light source 110 illuminates the sample area, thereby illuminating any sample material in the sample area, with light of a specific wavelength or wavelength range, and detector 130 detects illumination (e.g., fluorescence) emitted by the sample in the sample area. Simultaneously, detector 140 measures the stomatal conductance of the sample in sample area 120. In certain embodiments, system 100 advantageously enables making the necessary measurements of gₛ and fluorescence (and hence ETR) rapidly (e.g., <30 seconds) to prevent altering the biochemical status of the sample's (e.g., leafs) photosynthetic rate. In certain aspects, system 100 includes a housing or enclosure to hold the various components of the system, including inlet and outlet ports to control flow of gas into or out of the chamber defining the sample measuring region (sample area 120). FIG. 3 shows an example of a portable system/device including a sample area 320. As shown in an open state, a sample may be placed in sample area 320, and then the housing structure can be closed, wherein top portion 325 mates with bottom portion 326 to define an enclosed sample measuring region 320. In certain aspects, the sample is enclosed when measurements are taken using a photodetector and a humidity detector (e.g., Humicap). In certain other aspects, the sample can be analyzed in open air, for example, the leaf temperature, air temperature, humidity of open air, wind speed (e.g., taken using a sonic anemometer or other wind speed measuring instrument) and light intensity can be measured and used to calculate conductance by energy balance.

An intelligence module 150 (FIG. 2) such as a computer system, processor, ASIC, or other circuitry, receives signals from the detectors 130 and 140 and calculates a value of the carbon assimilation of the sample in sample area 120 in real-time as described in more detail below. The intelligence module may be integrated with the other components, e.g., illumination source 110, detectors 130 and 140, within a single housing or enclosure, as a single system or apparatus, or it may be separate, such as a standalone computer system directly or remotely coupled with the detectors. Alternately, signal data from detectors 130 and 140 can be stored to a separate memory unit (not shown) and transferred to a separate intelligence module for post-data-acquisition processing, either by way of a direct network connection, remote/wireless connection, or by way of transfer via a non-transient computer-readable medium such as a portable disk medium (CD, DVD, thumb drive, etc.). Additional detectors or sensors, such as temperature and pressure sensors, are included in certain embodiments (not shown) to measure various properties such as pressure and temperature of the sample or sample region. Also, an actinic light sensor can be included in certain embodiments. Actinic light is electromagnetic radiation having marked photochemical action. It often facilitates photosynthesis via light absorption by chlorophyll. It can be visible white or colored light or other electromagnetic radiation that can stimulate photosynthesis. Actinic light is distinguished from saturating light used in fluorescence measurements, the latter of which can be qualitatively similar (i.e. same wavelength regime) to the former, yet the saturation light is typically many times the intensity of full sunlight.

In one embodiment, the illumination source 110 illuminates the sample area with a pulse of saturating light or a series of pulses of saturating light. For example, in one embodiment, a pulse of subsaturating light using the multiphase method described below has an intensity above about 1,000 μmol m⁻² s⁻¹, thereby causing photochemical quenching (i.e. electron transfer) of excitation energy to approach zero. Different pulses may have the same or different intensity levels. However, in some cases extreme intensities of light can potentially damage the photosynthetic light capture proteins and molecules of the sample. Therefore, in one embodiment, the system 100 is configured with the ability to implement dynamic changes in pulse or flash irradiance of the sample, and is capable of nonetheless making accurate Fm′ calculations based on lower overall pulse intensities. A protocol, according to one embodiment, that implements the dynamic changes in the pulse irradiance intensity is referred to herein as multiphase flash (MPF) fluorescence and will be described in more detail below. In general, based on the use of sub-saturating pulse irradiances, implementing the MPF protocol enables more accurate estimation of ETR of the sample under investigation.

### Net Photosynthesis/Carbon Assimilation Determination

According to one embodiment, a method of calculating net photosynthesis (A) in C₃ plants from measurement of gₛ and fluorescence-based ETR is provided. For example, a conductance measurement can be combined with a fluorescence measurement to give an independent measurement of plant stress by allowing calculation of CO₂ uptake. Beginning with the equation for net photosynthesis (A):

$$A = {v}_{o} - \frac{1}{2} {v}_{o} - {R}_{a} = {v}_{o} ( 1 - \frac{{Γ}^{*}}{{C}_{c}} ) - {R}_{d} , and$$

$${V}_{O} + {V}_{C} = {V}_{C} ( 1 + \frac{2 {Γ}^{*}}{{C}_{o}} ) = {J}_{O 2} ( 1 - {f}_{1} )$$

$${g}_{m} = \frac{AP}{{c}_{i} - {Γ}^{*} \frac{{J}_{O 2} ( 1 - {f}_{1} ) + 2 A + 2 {R}_{d}}{{Jo}_{2} ( 1 - {f}_{1} ) - A - {R}_{d}}}$$

A can be restated as follows (see, e.g., He D. & Edwards G. E. (1996) Evaluation of the potential to measure photosynthetic rates in C₃ plants (Flaveria pringlei and Oryza sativa) by combining chlorophyll fluorescence analysis and a stomatal conductance model. Plant, Cell and Environment, 19, 1272-1280.):

$$A = {J}_{O 2} ( 1 - {f}_{1} ) ( \frac{{C}_{a} - AP ( \frac{1}{{g}_{s}} + \frac{1}{{g}_{m}} ) - {Γ}^{*}}{{C}_{a} - AP ( \frac{1}{{g}_{s}} + \frac{1}{{g}_{m}} ) - 2 {Γ}^{*}} ) - {R}_{d}$$

In one embodiment, the equation for A is solved as follows (see also Appendix A, page 1):

$$A = \frac{\begin{matrix}- ( {C}_{s} - 2 {Γ}^{*} - P ( \frac{1}{{g}_{s} {CO}_{2}} + \frac{1}{{g}_{m}} ) {R}_{d} + {Jo}_{2} ( 1 - {f}_{2} ) P ( \frac{1}{{g}_{s} {CO}_{2}} + \frac{1}{{g}_{m}} ) ) \pm \\ \sqrt{{( {C}_{s} 2 {Γ}^{*} - P ( \frac{1}{{g}_{s} {CO}_{2}} + \frac{1}{{g}_{m}} ) {R}_{d} + {Jo}_{2} ( 1 - {f}_{1} ) P ( \frac{1}{{g}_{s} {CO}_{2}} + \frac{1}{{g}_{m}} ) )}^{2} - 2 ( 1}\end{matrix}}{2 P ( \frac{1}{{g}_{s} {CO}_{2}} + \frac{1}{{g}_{m}} )}$$

where Cₐ is ambient, atmospheric CO₂ partial pressure (kPa), Γ* is the CO₂ partial pressure compensation point in the absence of photorespiration (kPa), fi is the fraction of electrons used in non-photosynthetic processes (unitless), P is the atmospheric pressure (kPa), g_{sCO2} is the stomatal conductance to CO₂ (mol CO₂ m⁻² s⁻¹) where g_{sCO2}=g_{sH2O}/1.6, gm is the mesophyll conductance to CO₂ (mol CO₂ m⁻² s⁻¹)(typically reported as mol CO₂ m⁻² s⁻¹ (unit of P)⁻¹, and therefore multiplied by total pressure to get mol CO₂ m⁻² s⁻¹), J_{O2}=ETR is the electron transport rate (i.e. assuming 4 mol e⁻ m⁻² s⁻¹=1 mol CO₂ m² s⁻¹), and Rd is the mitochondria respiration rate in the light (mol CO₂ m² s⁻¹). The resulting units for photosynthesis are mol CO₂ m⁻² s⁻¹.

Making measurements of g_{sH2O} can be done using a detector such as a porometer or infrared gas analyzer (IRGA). Steady-state and transient porometers have an advantage with respect to the short duration in which a measurement can be made. Steady-state porometers balance chamber water concentration by offsetting the water flux out of a leaf (transpiration) with a known amount of dry air entering the chamber. Stomatal conductance is calculated from the dry air flow, chamber vapor pressure, leaf saturation vapor pressure and leaf area (McDermitt D. K. (1990) Sources of error in the estimation of stomatal conductance and transpiration from porometer data. Horticultural Science, 25, 1538-1548.) Transient-state porometers measure the change in water concentration in time for a leaf and calculate the stomatal conductance from the water concentration change, chamber volume, leaf apoplastic volume water concentration and leaf area (McDermitt, 1990). IRGA technology can be used in similar fashions to the porometers, but instead of using a humidity sensor, an IRGA is used to measure water concentrations. Use of an IRGA may increase the total volume of the system, thereby increasing the time necessary to make the measurement. All three of these measurement systems, however, produce highly repeatable, precise and accurate measurements of stomatal conductance.

One of the possible fates of light absorbed by a leaf is re-emission as fluorescence. Due to unique PSII reaction center redox dynamics, PSII exhibits a special type of fluorescence referred to as variable fluorescence and from which an estimate of ETR can be obtained. ETR is an important indicator of photosynthetic capacity of plants and alterations in this capacity can be indicative of physiological stress to the plant. ETR is calculated from Fₘ′ according to

$$E T R = ( \frac{{F}_{m}^{′} - {F}_{s}}{{F}_{m}^{′}} ) fI {α}_{leaf}$$

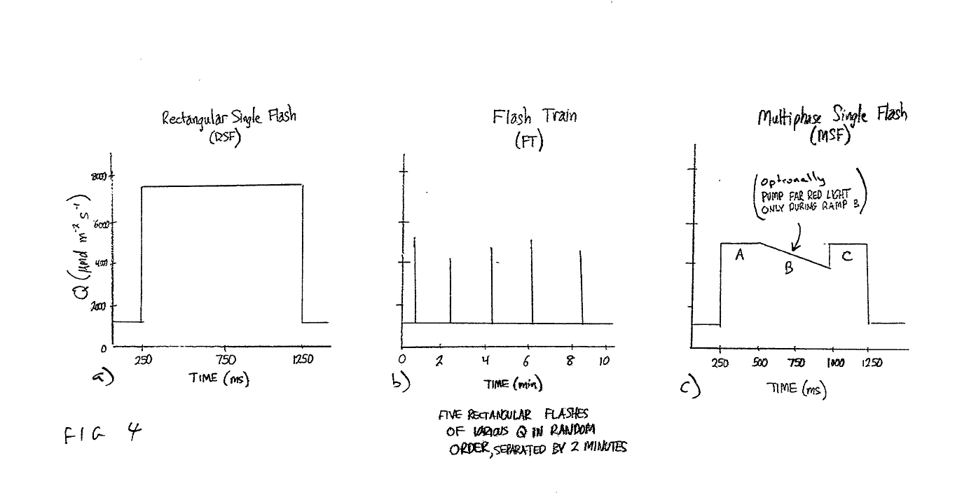

(see, e.g., Genty, Briantais & Baker, 1989) where Fs is the steady-state fluorescence yield, f is fraction of absorbed quanta partitioned to PSII, I is the incident light intensity, and α_{leaf} is the proportion of incident light that is actually absorbed by the leaf. Traditional methods of estimating Fₘ′ have relied on extremely intense (up to 10× full sunlight) pulses or flashes of light applied for short periods (˜1 second) such as shown in FIGS. 4a and 4b, but there is potential for such extreme intensities to damage the photosynthetic light capture proteins and molecules.

In one embodiment, the MPF protocol is used to reduce or eliminate such potential damage to the sample under investigation. As will be described in more detail below, the MPF protocol involves dynamic changes in flash irradiance and allows for accurate estimation of Fₘ′ using lower overall flash intensities. In one embodiment, as shown in FIG. 4C, an MPF is comprised of three contiguous phases of change in flash irradiance: from a given steady-state, and much lower, level of irradiance, a maximum irradiance is achieved during Phase 1 which is held constant for a brief time period (e.g., about 100 ms to 500 ms, typically about 300 ms), very similar to a traditional saturation flash; in contrast to a traditional saturation flash, Phase 2 of an MPF involves a brief (e.g., about 100 ms to 500 ms, typically between about 300 ms to 500 ms) linear attenuation or rampdown of the maximum Phase 1 irradiance, e.g., by between about 20-30%; and Phase 3 is comprised of a return to the Phase 1 irradiance for another brief time period (e.g., about 100 ms to 500 ms, typically about 300 ms), after which the flash sequence is terminated by return to the initial, steady-state irradiance. In certain embodiments, Phase 3 is not implemented, rather the MPF includes only Phase I and Phase II described above. Also, in certain embodiments, the Phase II irradiance attenuation can take on a shape other than linear.

The changes in irradiance during an MPF are clearly more complex than those during a traditional saturation pulse which can be described simply as a rectangular increase in irradiance, whereby a maximum intensity is achieved and held constant for between 0.5 s to 1 s (FIG. 4A). Accurate estimates of Fₘ′ can be difficult to achieve using traditional saturation pulses because of the difficulty of attaining the redox conditions necessary for saturation of Fₘ′. φ_{F} at extreme irradiances can be approximated as a linear function of the fluorescence yield plotted against the reciprocal of irradiance. A ‘true’ estimate of Fₘ′ can therefore be obtained via linear regression and extrapolation to infinite irradiance.

MPF with Far-Red Irradiance

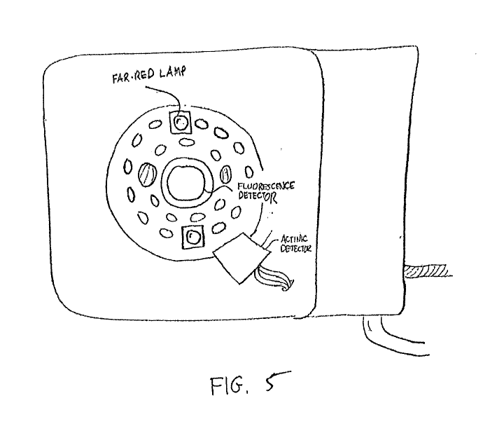

In some embodiments, fluorescence is measured using far-red light projected onto a leaf while applying a time-varying saturating pulse of light, e.g., shown as optional in FIG. 4C. The measured fluorescence off the plant tissue can then be used to determine Fm′, Φ_{PSII}, and the ETR, which can be indicative of plant stress. In these embodiments, for example, a system, such as system 100 of FIG. 2, will include a second light source configured to illuminate the sample area with far-red light of a desired frequency or frequency range. FIG. 5 illustrates an example of a system including a fluorescence detector, a light detector and a source of far red light, such as a lamp or other source that emits light having a wavelength between about 700 nm and about 850 nm.

A key prerequisite for estimating the true maximum fluorescence yield, or ^{T}Fm′, is complicated by biological photophysics. The yield of fluorescence emanating from the bulk antenna (i.e. the collection of 300-400 chlorophyll molecules per reaction center) of PSII is a function of a multitude of parallel, first-order processes that compete with one another for dissipating absorbed energy. De-convolving Φ_{PSII} from the relative quantum yields of these other processes is assumed to be achieved, in part, via use of the saturation pulse method.

To illustrate the underlying principle, the steady-state fluorescence yield, Fs, can be described mathematically as:

Fs=Φ_{F}=k_{F}/Σ(k_{F}+k_{ISC}+k_{IC}+k_{PC}[Q_{A}]+k_{NPQ}[Q]+k_{PQ}[PQ]) (Eqn. 1)

where k_{F}, k_{ISC}, k_{IC}, k_{PC}, k_{NPQ}, and k_{PQ} correspond to rate constants for fluorescence (F), intersystem crossing into the triplet state (ISC), internal conversion (IC), PSII-associated photochemistry (PC) leading to production of adenosine triphosphate (ATP) and/or nicotinamide adenine dinucleotide phosphate (NADPH), non-photochemical quenching (NPQ) (i.e. state transitions, or qT, qE, and inhibition quenching, or qI), and non-photochemical quenching by oxidized PQ, respectively. [Q_{A}], [Q], and [PQ] correspond to the proportions of oxidized Q_{A} (Q_{A}=Q_{A}/Σ[Q_{A}+Q_{A}−]), NPQ quenching sites (i.e. Z-bound sites), and oxidized PQ (PQ=PQ/Σ[PQ+PQH₂]), respectively.

It should be pointed out that k_{NPQ}[Q] is over-simplified in this equation because in reality the three distinct processes that contribute to NPQ involve other factors that are not evident in the expression. For example, it is well accepted that the components necessary and sufficient for q_{E} in higher plants include the pH component of the proton motive force, zeaxanthin (Z), and the antenna-based protein PsbS. A key tenant of estimating Φ_{PSII} using the saturation pulse method is the specific and complete reduction of Q_{A} to form Q_{A}⁻ during the pulse, a hypothetical circumstance that would allow ^{T}Fm′ to be described by:

^{T}Fm′=Φ_{F}=k_{F}/Σ(k_{F}+k_{ISC}+k_{IC}+k_{NPQ}[Q]+k_{PQ}[PQ]) (Eqn. 2)

That is, the term k_{PC}[Q_{A}]→0. An implicit assumption of this approach is that the SP solely causes Q_{A}→0; no changes in the relative yields of the other processes should occur. It should be noted that debate persists in the literature as to the extent of quenching of excitation energy by PQ. Some have made arguments that the PQ-pool is largely reduced at even modest background light intensities. Therefore, the term ‘k_{PQ}[PQ]’ is often neglected in mathematical formulations of fluorescence yield equations.

As such, the mathematical expression describing Φ_{PSII}([Fm′−Fs]/Fm′) routinely found in the literature is:

ΦPSII=k_{PC}[QA]/Σ(k_{F}+k_{ISC}+k_{IC}+k_{PC}[Q_{A}]+k_{NPQ}[Q]) (Eqn. 3)

Accurate estimation of Φ_{PSII} is predicated on the assumption that the rate constants in the denominator of Eqn. 3 remain constant during the saturation pulse. Conditions over which this above assumption remains valid may be difficult, if not impossible, to achieve. The yield of PSII electron transfer during the SP may itself preclude Q_{A}→0. Moreover, under steady-state illumination, only a certain fractional concentration of PQ may actually contribute to PSII-mediated electron transfer, depending upon the physiologic status of the plant, actinic intensity, etc. The precise role of PQ in quenching singlet, excited chlorophyll of PSII is still under intense investigation.

The validity of the constancy of the abovementioned rate constants during a saturation pulse is an issue that has been suggested to be problematic, especially at low actinic light levels. While it seems reasonable to assume that light intensity [Q] remains constant during the SP, e.g. given that the enzymes controlling the levels of electron transport (Z-scheme) operate over the minutes time-scale, the complex nature of the k_{NPQ} rate constant needs discussion. Recently, a comprehensive model has been proposed for control of q_{E} via charge-transfer quenching. This model posits that PsbS protein glutamate residues exposed in the lumen ‘sense’ the pH of the lumen, resulting in conformational changes that are transmitted to the minor complexes where even small conformational changes are predicted to modulate the orientation and/or distance of the excitonically-coupled pigments comprising the charge-transfer site. Such a mechanism is consistent with the well-established role of q_{E} in quickly responding to changes in incident light intensity that occur in nature. If a particular SP intensity transiently alters the pH local to the PsbS protein, it may be possible that transient changes in q_{E} occur, also invalidating the abovementioned assumption.

Furthermore, the very nature of Q_{A}→0 may have auxiliary consequences that likely prevent apparent maximum fluorescence yield (^{A}Fm′) as measured with traditional methods from approaching ^{T}Fm, for altogether different reasons. When Q_{A}→0, as presumably occurs during progressively increasing SP intensities, the quantum yield of PSII-mediated photochemistry approaches zero, thus increasing the intrinsic quantum yield of triplet quenching and other competing processes.

While the above equations do not contain rate constants for PSII-cyclic electron transfer or charge recombination of Q_{A}⁻/Q_{B}⁻ with oxidized states of the oxygen evolving complex, both of these processes have also been suggested to be capable of lowering fluorescence yield. While these processes are thought to have very low quantum yields, application of increasing SP intensities (i.e. increasing chlorophyll singlet excited states) could very well poise the PSII complex in a way that allows even modest increases in the quantum yields of these processes, preventing ^{T}Fm′ from being realized.

In some embodiments, a quasi-saturating pulse of light is applied to a leaf undergoing fluorescence analysis so as to cause the fluorescence yield to reach a ‘steady-state’, during the maximum irradiance of the pulse (i.e. this steady-state Φ_{F} during a pulse should not be confused with the abovementioned steady-state Φ_{F}, of Fs, obtained during actinic illumination) after which a ramping down of light intensity occurs transiently and during which Φ_{F} decreases hyperbolically. The light is then re-applied at the initial intensity to cause fluorescence yield to return to its pre-ramp level. ^{T}Fm′ is then derived via linear regression and extrapolation from a plot of Φ_{F} during the ramp versus 1/SP intensity.

Based on the MPF method, it is technically necessary for the fluorescence signal to remain constant prior to and after the ramping routine for extrapolated estimates to reflect ^{T}Fm′. At low SP intensities a gradual increase in fluorescence yield can be observed and is likely attributable to PQ-pool filling, an effect that can prevent the Φ_{F} from achieving a steady-state during the pulse.

The slow PQ-pool filling can also reflect photosystem I (PSI) turnover which is capable of being enhanced during a multiphase single flash (MPF) pulse. To help keep the PQ-pool from filling during Phases 1 and 2 of an MPF, a pulse of far-red light that is preferentially absorbed by PSI can be applied. Application of a far-red light pulse, e.g. at an intensity sufficient to keep the PQ-pool redox state constant, coincident with the MPF may allow steady-state Φ_{F} to be achieved at sub-saturating pulse intensities.

The MPF protocol is a method of accurately estimating Fm′ using lower overall flash intensities by altering the saturating pulse intensity during the flash. The MPF is comprised of three contiguous phases: Phase 1 is a maximum light intensity held constant; Phase 2 involves a brief, linear attenuation of the maximum Phase 1 irradiance by a fixed percentage and for a certain duration; and Phase 3 is a return to the maximum light intensity of Phase 1. A comparison of different flash techniques is depicted in FIG. 4. Phases 1, 2, and 3 correspond to regions A, B, and C in the right-hand chart of the FIG. 4C, respectively.

There is potential for the MPF method to underestimate ^{T}Fm′ because of the possibility of the biochemical reactions of electron transfer being slower than the rate of change in light intensity during Phase 2 of a flash event. An MPF is clearly more complex than a traditional saturation pulse which can be described simply as a rectangular increase in irradiance whereby a maximum intensity is achieved and held constant for between 0.5 s to 1 s (FIG. 4A).

Phase 2 typically involves a linear attenuation of irradiance by between about 20% and 30% (or more generally between about 10% and 50 of the maximum Phase I irradiance over a period of about 300 ms to about 600 ms. The amplitude of change in irradiance and duration of change determine the absolute rate of change in irradiance during Phase 2. For example, a linear attenuation by between 10% and 40% can be equivalent to ending the ramp at 90% of the starting value or 60% of the starting value, respectively. Accurate estimates of Fm′ are difficult to achieve using traditional (i.e., rectangular) saturation pulses because of the difficulty of achieving the redox conditions necessary for attaining full saturation of Fm′. However, it has been shown that Φ_{F} is hyperbolically dependent on irradiance and it has been shown both experimentally and theoretically that Φ_{F} can be approximated as a linear function of the reciprocal of irradiance.

A true estimate of Fm′ (^{T}Fm′) can be obtained through linear regression and extrapolation. Hyperbolic changes in Φ_{F} can be obtained using a single, ˜1 second MPF by attenuating the maximum Phase 1 irradiance by between 15% to 30%. However, the rates at which the Phase 1 irradiances are attenuated can preclude the key redox species that control Φ_{F} from changing fast enough. The resultant levels of Φ_{F} tend to be too high, ultimately rendering the resultant extrapolated values of Fm′ prone to underestimation.

Nonetheless application of far red (FR) light during Phase 2 of a MPF may be capable of modulating the changes in Φ_{F} so as to allow for optimization of extrapolated estimates of maximum Φ_{F}, or Fm′.

Application of FR light while attenuating the maximum irradiance of the MPF could function to facilitate more rapid changes in Φ_{F} in response to changing light flash intensities, ultimately facilitating more accurate determination of Fm′ via linear regression.

The FR light may function to preserve or accelerate the steady redox state of the PQ pool, thereby removing the changing biochemisty effects that confound both the traditional and MPF protocols. The reason is the light induces turnover of the reactions that oxidize the abovementioned key redox species. In some embodiments FR light is added to an MPF only during Phase 2, as shown in FIG. 4C.

Application of FR light during an MPF could improve on its utility. The MPF protocol has already been shown to provide accurate estimates of Fm′ that are used to derive the rates of electron transfer that occur during photosynthesis.

The absolute rate of change in irradiance during Phase 2 of the MPF is determined by both the duration and the total amplitude of change in irradiance. To achieve rates that ultimately provide optimal estimates of Fm′ based on the linear regression approach requires that the change in irradiance typically occur between ˜300-600 ms, effectively extending the total length of the MPF.

On the one hand, since the intensities typically used to estimate Fm′ during an MPF are several-fold higher than full sunlight and can potentially cause significant damage to the photosynthetic apparatus, extending the length of an MPF could be problematic.

On the other hand, shortening the length of time during which a given maximum irradiance is attenuated during an MPF, thereby decreasing the overall length of the MPF, can increase the rate of change in irradiance during Phase 2, ultimately causing the above-mentioned underestimation of the extrapolated value of Fm′.

Application of FR light could enable the use of shorter Phase 2 durations, which could otherwise perturb the redox state necessary for obtaining accurate estimates of Fm′, ultimately shortening the total length of an MPF. Therefore, the photosynthetic apparatus is protected from extended exposure to harmful intensities while simultaneously facilitating changes in Φ_{F} from which accurate estimates of extrapolated Fm′ can be obtained.

FR light can be applied throughout Phases 1-3. Data from such tests indicates that both the Φ_{F} achieved during Phase 1 and the resultant extrapolated values of Fm′ decreased.

However, by attenuating the Phase 1 Φ_{F}, the extrapolated values were also lower; an undesirable outcome. The Φ_{F} that should be lowered when using fast attenuation rates is the Phase 2 Φ_{F}. Turning on the FR light during Phase 2 gave results indicating that Phase 1 Φ_{F} remained constant as a function of FR light intensity.

While FR light is used for other applications, it's use during a saturation pulse, especially an MPF, is novel. FR light is capable of lowering Φ_{F}; this lowering of Φ_{F} is due to FR light being capable of modulating the redox state of Q_{A}, a unique redox species within the PSII reaction center that increases the Φ_{F} originating from the chlorophyll antanne of PSII upon accumulation of negative charge (i.e. Q_{A}⁻). It is surmised that PS I, which receives electrons in series from PSII, is enriched in chlorophyll a, increasing near FR absorption and augmenting electron transport activity through the PS I, thereby enhancing oxidation Q_{A}.

In the prior art, application of FR light is used in some laboratory experiments in order to preferentially activate PS I during a light-adapted to dark-transition in order to drain all electrons from PSII so as to obtain an approximate measure of the minimum Φ_{F} in a light adapted state. However, the application of FR light during such experiments does not occur during a saturation pulse, but is applied rather to a leaf after the saturating flash and when the actinic light is turned off.

Remote fluorescence measurement may be obtained using a gun-like apparatus, as shown in FIG. 13. The gun can have a lower chamber which couples with the leaf while the upper portion of the leaf is exposed for remote measurement of fluorescence. Upon pulling a trigger, an MPF can be emitted (with optional, supplemental far-red light irradiance), and fluorescence can be measured. Such a device may be easier to use in the field.

All US patents and applications, and journal articles, mentioned herein are hereby incorporated by reference in their entirety for all purposes.

It should also be understood, that as used herein, the term wavelength or wavelengths (or frequency or frequencies) with reference to illumination sources and detectors means the wavelength (or frequency) range or ranges at which a source emits or at which a detector detects (or at which a fluorescent species emits). For example, a laser source may be said to emit at a certain specific wavelength, e.g., 680 nm, however, one skilled in the art understands that the specific wavelength refers to a wavelength bandwidth centered at the specific emission wavelength. Similarly, a detector detects over a range of wavelengths.

It should be appreciated that the carbon assimilation determination processes described herein may be implemented in processor executable code running on one or more processors. The code includes instructions for controlling the processor(s) to implement various aspects and steps of the carbon assimilation determination processes. The code is typically stored on a hard disk, RAM or portable medium such as a CD, DVD, etc. The processor(s) may be implemented in a control module of an integrated measurement system or device, or in a different component of the system having one or more processors executing instructions stored in a memory unit coupled to the processor(s). Code including such instructions may be downloaded to the system memory unit over a network connection or direct connection to a code source or using a portable, non-transient computer-readable or processor-readable medium as is well known.

One skilled in the art should appreciate that the processes of the present invention can be coded using any of a variety of programming languages such as C, C++, C#, Fortran, VisualBasic, etc., as well as applications such as Mathematica® which provide pre-packaged routines, functions and procedures useful for data visualization and analysis. Another example of the latter is MATLAB®.

Appendix A illustrates various aspects and concepts pertinent to the various embodiments herein.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of estimating carbon assimilation of a sample containing chlorophyll (chlorophyll sample), the method comprising:
illuminating the chlorophyll sample with light;
measuring a chlorophyll fluorescence of the chlorophyll sample;
measuring a stomatal conductance of the chlorophyll sample; and
calculating a carbon assimilation value for the chlorophyll sample based on the measured chlorophyll fluorescence and the measured stomatal conductance.

2. The method of claim 1, wherein calculating includes:
determining a maximal fluorescence value (Fm′) of the chlorophyll sample using the measured chlorophyll fluorescence; and
estimating an effective quantum efficiency of a photosystem II (Φ_{PSII}) or electron transport rate (ETR) of the chlorophyll using the Fm′ value,
wherein the carbon assimilation value for the chlorophyll sample is calculated using the ETR value and the measured stomatal conductance.

3. The method of claim 1, wherein illuminating the chlorophyll sample includes applying a pulse of saturating light upon the chlorophyll sample.

4. The method of claim 3, wherein illuminating the chlorophyll sample further includes varying an intensity of the saturating light during the pulse.

5. The method of claim 4, wherein the varying of the intensity of the saturating light includes ramping the intensity.

6. The method of claim 4, wherein varying of the intensity of saturating light includes adjusting the intensity such that the applied pulse has a shape of a rectangular pulse of a first intensity, immediately followed by a ramp down in intensity.

7. The method of claim 4, further including irradiating the chlorophyll sample with far-red light during the varying of the intensity of the saturating light, wherein the far-red light has a wavelength of between about 700 nm and about 850 nm.

8. The method of claim 3, wherein the pulse of saturating light has an intensity above 1,000 μmol m⁻² s⁻¹, thereby enabling measurement of the change in fluorescence yield with the change in flash intensity for use in estimating fluorescence yield at infinite light.

9. The method of claim 1, wherein the illuminating light is white light or a combination of colored lights.

10. The method of claim 1, wherein the chlorophyll sample includes plant tissue.

11. The method of claim 10, wherein the plant tissue includes a leaf or other photosynthetic plant tissue.

12. The method of claim 1, wherein the chlorophyll sample is a non-plant photosynthetic organism or apparatus.

13. The method of claim 1, wherein measuring a stomatal conductance of the chlorophyll sample is done using one of a porometer or an infra-red gas analyzer (IRGA).

14. A plant photosynthesis monitoring system comprising:
a first illumination source configured to illuminate a sample area with light;
a first detector configured to measure a chlorophyll fluorescence of a chlorophyll sample in the sample area;
a second detector system configured to measure a stomatal conductance of the chlorophyll sample; and
a processor adapted to calculate a carbon assimilation value for the chlorophyll sample based on the measured chlorophyll fluorescence and the measured stomatal conductance.

15. The apparatus of claim 14, wherein the processor is further adapted to:
determine a maximal fluorescence (Fm′) using the measured chlorophyll fluorescence from the first detector; and
estimate an effective quantum efficiency of a photosystem II (Φ_{PSII}) or electron transport rate (ETR) of the chlorophyll sample using the Fm′ value,
wherein the processor calculates the carbon assimilation value for the chlorophyll sample using the ETR value and the measured stomatal conductance.

16. The apparatus of claim 14, wherein the first illumination source is configured to illuminate the chlorophyll sample in the sample area by applying a pulse of saturating light, and wherein first detector measures the chlorophyll fluorescence from the sample area during the pulse.

17. The apparatus of claim 16, wherein the first illumination source is configured to vary an intensity of the saturating light during the pulse.

18. The apparatus of claim 17, further including a second illumination source configured to irradiate the chlorophyll sample with far-red light as the intensity of the saturating light is varied, wherein the second illumination source is configured to emit far-red light having a wavelength of between about 700 nm and about 850 nm.

19. The apparatus of claim 17, wherein the first illumination source varies the intensity of the saturating light by ramping the intensity.

20. The apparatus of claim 17, wherein the first illumination source varies the intensity of the saturating light by adjusting the intensity such that the applied pulse has a shape of a rectangular pulse of a first intensity, immediately followed by a ramp down in intensity.

21. The apparatus of claim 16, wherein the pulse of saturating light has an intensity above 1,000 μmol m⁻² s⁻¹, thereby enabling measurement of the change in fluorescence yield with the change in flash intensity for use in estimating fluorescence yield at infinite light.

22. The apparatus of claim 14, wherein the first detector includes a photodetector.

23. The apparatus of claim 14, wherein the second detector system includes a porometer or an infra-red gas analyzer (IRGA).

24. The apparatus of claim 14, wherein the first illumination source is selected from the group consisting of a white LED, a red LED, a blue LED, and a xenon bulb with a hot mirror.

25. A plant photosynthesis monitoring system comprising:
a first illumination source configured to illuminate a sample area with light;
a fluorescence detector configured to measure a chlorophyll fluorescence of a chlorophyll sample in the sample area;
a porometer or infra-red gas analyzer configured to measure a stomatal conductance of the chlorophyll sample; and
a processor adapted to calculate a carbon assimilation value for the chlorophyll sample based on the measured chlorophyll fluorescence and the measured stomatal conductance.

26. The system of claim 25, wherein the sample area is enclosed within a chamber.
